(19) United States
(12) Patent Application Publication
(10) Pub. No.: US 2025/0288174 A1
(43) Pub. Date: Sep. 18, 2025

(54) SURFACE MAINTENANCE MACHINES HAVING VISUAL INDICIA FOR MAINTENANCE INTERVALS

(71) Applicant: Tennant Company, EDEN PRAIRIE, MN (US)

(72) Inventors: Grant Daniel Leacox, Minneapolis, MN (US); Reid Rabon, Minneapolis, MN (US)

(21) Appl. No.: 19/081,335

(22) Filed: Mar. 17, 2025

Related U.S. Application Data
(60) Provisional application No. 63/566,612, filed on Mar. 18, 2024.

(51) Int. Cl. A47L 11/40

(52) U.S. Cl. CPC A47L 11/4008; A47L 11/4005; A47L 11/4088

(57) ABSTRACT

A surface maintenance machine may include first markings on the surface maintenance machine that bear a first visual indicia consistent with a first maintenance frequency, the first markings corresponding to first service components of the surface maintenance machine, and second markings on the surface maintenance machine that bear a second visual indicia consistent with a second maintenance frequency, the second visual indicia being visually different from the first visual indicia, the second markings corresponding to second service components of the surface maintenance machine. A user may determine if a first time period corresponding to the first maintenance frequency has elapsed, and, if so, performing the one or more maintenance tasks on the first service components, and if a second time period corresponding to the second maintenance frequency has elapsed, and, if so, performing the one or more maintenance tasks on the second service components.

### CROSS REFERENCE TO RELATED APPLICATION

This application claims priority to U.S. Provisional Patent Application No. 63/566,612, filed Mar. 18, 2024, the entire contents of which are incorporated herein by reference.

### TECHNICAL FIELD

This disclosure relates generally to surface maintenance machines. More particularly, the present disclosure relates to surface maintenance machines having visual indicia corresponding to maintenance intervals.

### BACKGROUND

Surface maintenance machines can be used to perform one or more surface maintenance tasks such as brushing, cleaning, polishing, and stripping surfaces. To perform one or more surface maintenance tasks, surface maintenance machines require regular maintenance to sustain normal operation of the surface maintenance machines.

Following operation of the machine, one or more maintenance tasks may need to be performed on the machine. Some maintenance tasks may be required daily tasks and others may be required weekly or monthly tasks. However, operators of the machines may not always know what type of maintenance tasks need to be performed or when said tasks need to be performed on the machines. Further there may be several operators performing surface maintenance tasks using a same machine, or a large turnover of employees, and therefore each operator may not know if or when maintenance tasks have been performed on the machine. This can lead to damage of the machine which in turn leads to service calls and/or downtime of the machine. What would be desirable is a maintenance schedule that is clearly visible by the operators that highlights necessary maintenance tasks and indicates how frequently said maintenance tasks should be completed.

### SUMMARY

In general, the present disclosure relates to surface maintenance machines having visual indicia corresponding to maintenance intervals. In one example, a method of servicing a surface maintenance machine may include identifying first markings on the surface maintenance machine that bear a first visual indicia, the first markings corresponding to first service components of the surface maintenance machine, the first visual indicia being consistent with a first maintenance frequency. Identifying second markings on the surface maintenance machine that bear a second visual indicia, the second visual indicia being visually different from the first visual indicia, the second markings corresponding to second service components of the surface maintenance machine, the second visual indicia being consistent with a second maintenance frequency different from the first maintenance frequency. The method may further include determining if a first time period corresponding to the first maintenance frequency has elapsed since a most recent performance of one or more maintenance tasks on the first service components, and, if so, performing the one or more maintenance tasks on the first service components, and determining if a second time period corresponding to the second maintenance frequency has elapsed since a most recent performance of one or more maintenance tasks on the second service components, and, if so, performing the one or more maintenance tasks on the second service components.

In another example, a method of creating a surface maintenance machine having indicators of a maintenance schedule may include providing a surface maintenance machine. The maintenance machine may include a mobile body, a solution tank for containing a supply of a cleaning fluid, wheels for supporting and transporting the mobile body, one or more surface maintenance tools supported by the mobile body, a first set of service components, and a second set of service components. The method may further include installing first markings on the surface maintenance machine that bear a first visual indicia, the first markings corresponding to the first service components of the surface maintenance machine, the first visual indicia being consistent with a first maintenance frequency, the first markings being provided as part of or adjacent to the first service components, and installing second markings on the surface maintenance machine that bear a second visual indicia, the second visual indicia being visually different from the first visual indicia, the second markings corresponding to the second service components of the surface maintenance machine, the second visual indicia being consistent with a second maintenance frequency different from the first maintenance frequency, the second markings being provided as part of or adjacent to the second service components.

In a further example, a surface maintenance machine having indicators of a maintenance schedule may include a mobile body, a solution tank for containing a supply of a cleaning fluid, wheels for supporting and transporting the mobile body, one or more surface maintenance tools supported by the mobile body, a first set of service components, and a second set of service components. The surface maintenance machine may further include first markings on the surface maintenance machine that bear a first visual indicia, the first markings corresponding to first service components of the surface maintenance machine, the first visual indicia being consistent with a first maintenance frequency, the first markings being provided as part of or adjacent to the first service components, and second markings on the surface maintenance machine that bear a second visual indicia, the second visual indicia being visually different from the first visual indicia, the second markings corresponding to second service components of the surface maintenance machine, the second visual indicia being consistent with a second maintenance frequency different from the first maintenance frequency, the second markings being provided as part of or adjacent to the second service components.

The details of one or more examples are set forth in the accompanying drawings and the description below. Other features, objects, and advantages will be apparent from the description and drawings, and from the claims.

### BRIEF DESCRIPTION OF DRAWINGS

The following drawings are illustrative of particular embodiments of the present disclosure and, therefore, do not limit the scope of the disclosure. The drawings are intended for use in conjunction with the explanations in the following description. Embodiments of the disclosure will hereinafter be described in conjunction with the appended drawings, wherein like numerals denote like elements. The features illustrated in the drawings are not necessarily to scale, though embodiments within the scope of the present disclosure can include one or more of the illustrated features at the scale shown.

FIG. 1 is a perspective view of the front and right side of an exemplary surface maintenance machine.

FIG. 2 is a perspective view of the rear and right side of the surface maintenance machine of FIG. 1 showing basic components of the surface maintenance machine.

FIG. 3 is a lower, right-side view of the surface maintenance machine of FIG. 1 showing a cleaning head assembly, a first squeegee, and a second squeegee.

FIG. 4 is a rear view of the surface maintenance machine of FIG. 1 showing an electrical charge cord wrapped around a cord caddy.

FIG. 5 is a left-side view of the surface maintenance machine of FIG. 1 showing second markings corresponding to a cleaning solution filter.

FIG. 6 is a top view of the surface maintenance machine of FIG. 1 with a recovery tank lid in an open position, showing first markings bearing a first visual indicia and second markings bearing a second visual indicia.

FIG. 7 illustrates an example maintenance schedule showing first markings bearing a first visual indicia and second markings bearing a second visual indicia.

FIG. 8 illustrates an example flow chart for a method of servicing a surface maintenance machine.

FIG. 9 illustrates an example flow chart for a method of creating a surface maintenance machine.

### DETAILED DESCRIPTION

Exemplary embodiments of the present disclosure can be included, and executed, at a surface maintenance machine 100. Such surface maintenance machines 100 require one or more maintenance tasks be performed on the machine 100 to ensure proper operation of the machine 100, as well as longevity of the machine 100. In some cases, one or more maintenance tasks may need to be performed on the machine. Some maintenance tasks may be required daily tasks and others may be required weekly or monthly tasks. However, operators of the machines may not always know what type of maintenance tasks need to be performed or when said tasks need to be performed on the machines. Further there may be several operators performing surface maintenance tasks using a same machine, or a large turnover of employees, and therefore each operator may not know if or when maintenance tasks have been performed on the machine. This can lead to damage of the machine which in turn leads to service calls and/or downtime of the machine. Therefore, providing a machine 100 that includes first markings on the surface maintenance machine 100 and second markings on the surface maintenance machine indicative of a maintenance schedule may be advantageous.

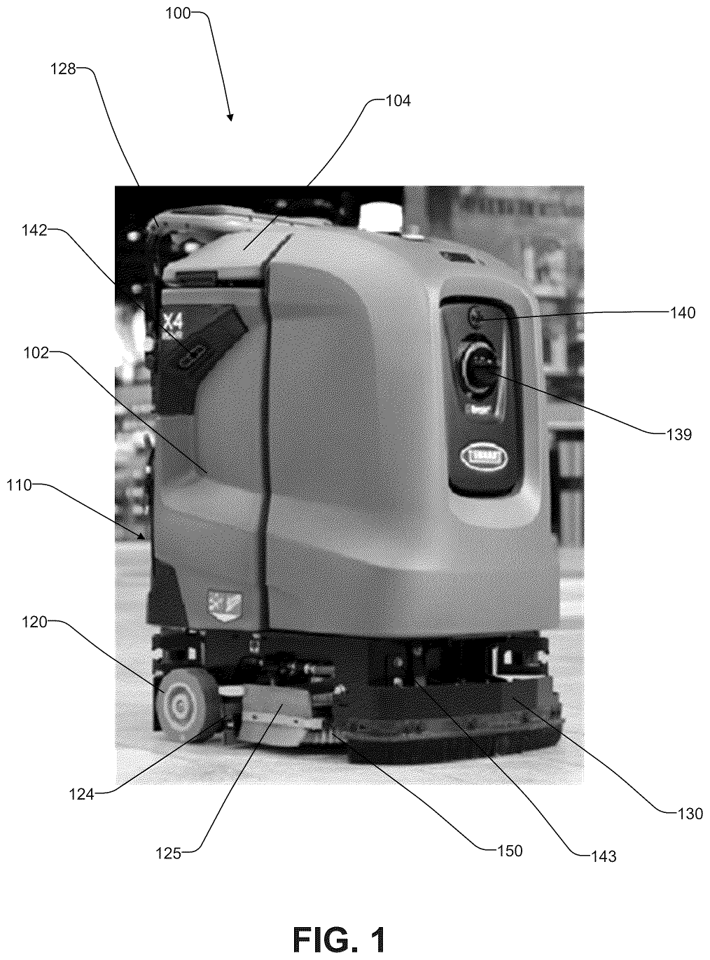

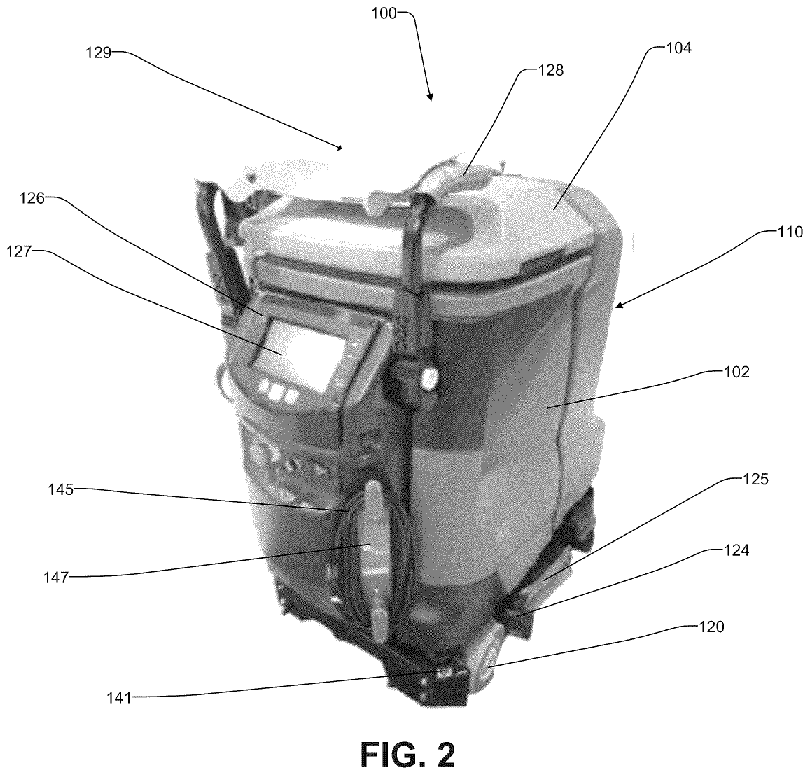

FIG. 1 is a perspective view of the front and right side of the exemplary surface maintenance machine 100, and FIG. 2 is a perspective view of the rear and right side of the surface maintenance machine 100. In the illustrated embodiment, the machine 100 is a walk-behind surface maintenance machine (e.g., for performing one or more surface maintenance tasks at a hard floor surface). In other embodiments, the machine can instead be a ride-on machine or an autonomously driven machine. Embodiments of the machine 100 include one or more surface maintenance tools, a first set of service components, and a second set of service components that are supported on a motorized mobile body 110. The mobile body 110 comprises a frame supported on wheels 120 for travel over a surface, on which a floor treating operation is to be performed, and a perimeter guard 130. As shown in FIG. 2, the mobile body 110 includes a grab handle 128, a bail 129, and operator controls, including a manual/autonomous mode user input mechanism 126. The user input mechanism 126 may include a user interface 127, with may include an interactive touch screen with which a user may interact to control the machine 100. The machine 100 can be powered by an on-board power source, such as one or more batteries.

The machine 100 generally includes a base 102, that includes a frame, and a lid 104, which is attached along a side of the base 102 by hinges so that the lid 104 can be pivoted up to provide access to the interior of the base 102. The interior of the base 102 can also include a battery source and other electrical components of the machine 100. The base interior can also include a fluid source tank and a fluid recovery tank. The fluid source tank contains a fluid source such as a cleaner or sanitizing fluid that can be applied to the floor surface during treating operations. The fluid recovery tank holds recovered fluid source that has been applied to the floor surface and soiled.

The base 102 also includes a fluid recovery device, which includes a first squeegee 124A and a second squeegee 124B. The first and second squeegees 124A, 124B may be in vacuum communication with a fluid recovery tank. In operation, the first and second squeegees 124A, 124B recover soiled fluid from the floor surface and helps transport it to the recovery tank. The base 102 further includes a third squeegee 125 which may be positioned at a lower side of the base 102. While the third squeegee 125 is shown positioned on a lower right side of the base 102, it may be contemplated that a fourth squeegee may further be positioned at a lower left side of the base 102 (although not explicitly shown). The base 102 carries a cleaning head assembly 150. The cleaning head assembly 150 can be attached to the base 102 such that the cleaning head assembly 150 can be lowered to a cleaning position and raised to a traveling position. The cleaning head assembly 150 is interfaced with an existing machine using any known mechanism, such as a suspension and lift mechanism. The cleaning head assembly 150 may include one or more rotatable brushes, such as disc-shaped or cylindrical scrub brushes. Alternatively, the cleaning head assembly 150 may include other cleaning tools such as a sweeping brush, or polishing, burnishing, or buffing pads. The brushes or pads are held by a driver (e.g., a brush driver or a pad driver respectively) that, together with the brush or pad, is detachable from a hub of the cleaning head assembly 150. In certain embodiments, the cleaning head assembly 150 includes a magnetic coupling system that allows for touch-free attachment and aligning between the pad driver or brush driver and the hub.

When the machine 100 is operated in a manually driven mode, the grab handle 128 and the bail 129 can be configured to cause the machine 100 to move along a surface at which a surface maintenance task is desired to be performed. To begin moving the machine 100, the user can grasp the grab handle 128 and actuate the bail 129 to cause a motive force to be applied at the machine 100. For example, the bail 129 can be configured to be actuated via a user applying a pull force at the bail 129 (e.g., to move the bail 129 toward the grab handle 128). A first actuation (e.g., a user applied pull force at the bail 129) of the bail 129 can activate application of the motive force at the machine 100, and a second actuation (e.g., a user releasing, and thus terminating the pull force at, the bail 129) of the bail 129 can terminate application of the motive force at the machine 100. The grab handle 128 can provide a surface at which a user of the machine 100 can grasp the machine 100 during manual operation and apply desired user user-originated forces. For instance, in the manually driven mode, the grab handle 128 can be grasped and used by a user to apply user forces at the machine 100 in different directions to cause the machine 100 to move forward, move rearward, and turn in various directions.

In some cases, the machine 100 can include a controller (not explicitly shown). The controller can be, for example, a programmable processor that is configured to execute non-transitory computer-readable instructions stored in a non-transitory memory component (e.g., at the controller). As one example, the controller can include a controller from Roboteq™ serial number SBLM2360T. Execution of the non-transitory computer-readable instructions at the controller can cause the machine 100 to perform one or more various features disclosed herein.

The bail 129 can be coupled to the controller, via a wired or wireless protocol. As noted, the bail 129 be configured to be actuated to cause the machine 100 to move along a surface at which a surface maintenance task is desired to be performed. When actuated, the bail 129 can be configured to send a corresponding bail input signal to the controller. The controller can receive the bail 129 input signal and, in response, output a control signal to one or more components at the machine 100 (e.g., one or both independently controlled motors) to cause such one or more components to take a corresponding action.

The manual/autonomous mode user input mechanism 126 can be coupled to the controller, via a wired or wireless protocol. The manual/autonomous mode user input mechanism 126 can receive one or more inputs thereat from the user of the machine 100 and, as a result, send one or more corresponding input signals to the controller. For example, the manual/autonomous mode user input mechanism 126 can be configured, when actuated, to send a mode control signal to the controller corresponding to one of a manual mode command and an autonomous mode command. For instance, a first actuation of the manual/autonomous mode user input mechanism 126 can cause the manual/autonomous mode user input mechanism 126 to send a manual mode control signal to the controller, and a second, different actuation of the manual/autonomous mode user input mechanism 126 can cause the manual/autonomous mode user input mechanism 126 to send an autonomous mode control signal to the controller. As illustrative examples the first actuation of the manual/autonomous mode user input mechanism 126 can be a user providing a manual mode selection at the manual/autonomous mode user input mechanism 126 (e.g., via a manual mode button at the manual/autonomous mode user input mechanism 126) and the second actuation of the manual/autonomous mode user input mechanism 126 can be a user providing an autonomous mode selection at the manual/autonomous mode user input mechanism 126 (e.g., via an autonomous mode button at the manual/autonomous mode user input mechanism 126).

When the controller receives the manual mode command from the manual/autonomous mode user input mechanism 126, the controller can, in response, execute non-transitory computer-readable instructions to cause the machine 100 to be configured for operation in a manually driven mode. Likewise, when the controller receives the manual mode command from the manual/autonomous mode user input mechanism 126, the controller can, in response, execute non-transitory computer-readable instructions to cause the machine 100 to be configured for operation in an autonomously driven mode.

When the surface maintenance machine 100 is configured for operation in the manually driven mode (e.g., in response to the controller receiving the mode control signal corresponding to the manual mode command), a torque assist user mechanism can be enabled to send a torque assist control signal to the controller.

The surface maintenance machine 100 can also include a power source, a first wheel motor, a first driven wheel 220, a second wheel motor, and a second driven wheel (not explicitly shown). The power source can be, for instance, one or more rechargeable batteries. The machine 100 may include an electrical charge cord 145 that may be operatively coupled to the power source, (e.g., the one or more rechargeable batteries). The electrical charge cord 145 may be stored on the machine 100 using a power cord caddy 147. The power source can be configured to provide operational power to various (e.g., all) powered components at the machine 100.

As noted, the machine 100 can be switched between manually driven and autonomously driven modes (e.g., via actuation of the manual/autonomous mode user input mechanism 126). To facilitate operation of the machine 100 in the autonomously driven mode, the machine 100 can include onboard one or more vision sensors 139. The vision sensor 139 can be coupled to the controller, via a wired or wireless protocol. The vision sensor 139 can be configured to scan and detect features in the ambient environment of the machine 100. In some embodiments, the vision sensor 139 can include one or more of visible light and/or thermal (infrared) vision cameras, LIDAR sensors, laser beacons, ultrasound sensors, and the like to detect features of the environment (such as physical boundaries and the like). In some embodiments, the vision sensors 139 can be provided at various, spaced apart locations on the machine 100 (e.g., front, lateral sides, rear, and the like) so as to obtain data corresponding to areas at different locations around the machine 100 over a relatively wide field of view. In some particular embodiments, the field of view of the vision sensors 139 can correspond to an angle of between about 200 degrees and about 300 degrees, and a radius of between about 50 feet and 150 feet. In one yet more particular embodiment, the field of view of the vision sensors 139 can be approximately 240 degrees and a radius of approximately 90 feet.

In certain embodiments, also to help facilitate operation of the surface maintenance machine 100 in the autonomously driven mode, the machine 100 can also include a front camera 140, a front lower sensor 143, a rear lower sensor 141, and a side camera 142. While it is shown that the machine 100 includes a singular front lower sensor 143, a singular rear lower sensor 141, and a singular side camera 142, it will be appreciated that the machine 100 may include additional rear lower sensors, front lower sensors, and side cameras. For example, as the front lower sensor 143 is shown on the front lower right side of the machine 100, it will be appreciated that the front lower left side includes an additional front lower sensor. The front lower sensor 143, the rear lower sensor 141, and the side camera 142 may be coupled to the controller, and the front lower sensor 143, the rear lower sensor 141, and the side camera 142 may each include a wireless transceiver configured to output a wireless signal and receive a wireless signal. The front lower sensor 143, the rear lower sensor 141, and the side camera 142 may permit ascertaining localization the machine 100, such as before, during, or after mapping of a location at which the machine 100 is to operate autonomously. In some embodiments, one or more of the front lower sensor 143, the rear lower sensor 141, and the front vison sensor 139 can include a Global Positioning System (“GPS”) sensor. Alternatively, or in addition, one or more of the front lower sensor 143, the rear lower sensor 141, and the front vision sensor 139 may include an inertial measurement unit (e.g., compass, accelerometer, gyroscope, magnetometer and the like). In addition, additional components such as wireless communication beacons (e.g., WiFi or Bluetooth) can be provided at the one or more of front lower sensor 143, the rear lower sensor 141, and the front vision sensor 139 to improve accuracy of localization.

To further assist operation of the surface maintenance machine 100 in the autonomously driven mode, the machine 100 can include a mapping system. The mapping system can, for instance, be executed at the controller, such as via a mapping processor and mapping computer-executable instructions at the controller. The mapping processor can have one or more integrated circuits that can be in electrical communication with an on-board or a remote non-transitory memory component. The memory component can store mapping instructions in the form of a mapping software program that can be executed by the mapping processor to generate a map for use by the machine 100 to navigate a location in the autonomously drive mode. The mapping processor can be coupled (e.g., via the controller) to the one or more vision sensors 139 and/or front lower sensor 143, the rear lower sensor 141, and the side camera 142. For instance, the mapping processor can be coupled (e.g., via electrical circuits provided on the machine 100) to the vision sensors 139 and/or front lower sensor 143, the rear lower sensor 141, and the side camera 142 such that data collected by vision sensors 139 (e.g., electrical signals representative thereof) and/or the front lower sensor 143, the rear lower sensor 141, and the side camera 142 can be transmitted to the mapping processor via the electrical circuits. The mapping processor can also send control signals to initiate data collection at the vision sensors 139 and/or the front lower sensor 143, the rear lower sensor 141, and the side camera 142.

In some examples, the mapping system can also include a visualization processor. The visualization processor can be provided as a part of the controller (e.g., GPGPU component at the controller) at the surface maintenance machine 100. The visualization processor can have one or more integrated circuits that can be in electrical communication with the mapping processor. Additionally, the visualization processor can be in electrical communication with the on-board and/or remote memory component. The memory can store computer-readable visualization instructions in the form of a visualization software program that can be executed by the visualization processor to generate a map of the location at which the machine 100 is to be autonomously operated. The controller can then execute the generated map to provide control signals to motors.

When in the autonomously driven mode, the surface maintenance machine 100 can be configured to operate in a speed control mode (sometimes referred to as velocity control mode) for applying motive force, via the independently controlled motors, to the driven wheels (e.g., wheel 120). For example, the controller can execute a speed control mode program stored in a non-transitory memory component at the machine 100 in the form of computer-readable instructions executable by the controller to cause the controller to control movement of the machine 100 via the speed control mode.

Following operation of the machine 100, one or more maintenance tasks may be performed on the machine 100 to ensure proper operation of the machine 100, as well as longevity of the machine 100. The one or more maintenance tasks may include a first time period corresponding to a first maintenance frequency and/or one or more maintenance tasks that include a second time period corresponding to a second maintenance frequency. In some cases, the first time period may correspond to a number of days in a range of about one day to about seven days. For example, the first time period may correspond to one day. In some cases, the first time period may correspond to an amount of time the surface maintenance machine 100 has been used. For example, the first time period may correspond to an amount of time in a range of about 50 hours to about 1,250 hours. In such examples, the first maintenance frequency may be once per day. For example, the first maintenance frequency may be once per day and the first time period may be one day. In other words, the one or more maintenance tasks may be performed once every day. In another example, the first maintenance frequency may be once per 200 hours of machine use, and the first time period may be 200 hours of machine 100 use. In other words, the one or more maintenance tasks may be performed once after every 200 hours of machine 100 use.

In some cases, the second time period may correspond to a number of days in a range of about two days to about seven days. For example, the second time period may correspond to seven days. In such examples, the second maintenance frequency may be once every seven days. For example, the second maintenance frequency may be once and the second time period may be seven days (e.g., once a week).

The surface maintenance machine 100 may include first markings that bear a first visual indicia, and second markings that bear a second visual indicia, wherein the second visual indicia is visually different from the first visual indicia. The first visual indicia may correspond to the first service components of the machine 100, and the second visual indicia may correspond to the second service components of the machine 100. The first markings and the second markings may be provided on the machine 100 to highlight the first maintenance frequency and the second maintenance frequency for the one or more maintenance tasks, which assists an operator of the machine 100 in knowing which tasks need to be performed. For example, one or more maintenance tasks may need to be performed on a daily basis, whereas another of the one or more maintenance tasks may only need to be performed on a weekly basis.

In some cases, the first markings that bear the first visual indicia may be provided on the first service components, positioned adjacent to the first service components, and/or provided as a part of the first service components. For example, the first markings may be positioned on an actuator that is used while performing the one or more maintenance tasks on the first service components. In another example, the first markings may include a portion of the first service components bearing the first visual indicia. In some cases, the first visual indicia may include a first color. In some cases, the first color is yellow. In other cases, the first color may be teal, purple, blue, or any other suitable color. In some cases, the first visual indicia may include a decal incorporating the first color that may be positioned on the machine 100 adjacent to the first service components.

In some cases, the first visual indicia may include a first color and/or a decal including braille instructions. These are just examples. In some examples, the first visual indicia and the second visual indicia may include patterns, combinations of colors, images, symbols (e.g., letters, words, characters, graphics), etc. In one aspect, the first or second visual indicia could be a calendar to indicate that the first frequency or the second frequency corresponds to once per month. The differences between the first visual indicia and the second indicia may be apparent to a user in order to distinguish between service components to be maintained at a first frequency and service components to be maintained at a second frequency. The use of first visual indicia and second visual indicia is merely one example and could be extended to additional visual indicia. In some examples there are third, fourth, fifth, and possibly more different visual indicia, each having apparent differences, each corresponding to a particular maintenance frequency, and each being marked on, adjacent to, or part of particular service components.

As stated, the first visual indicia may correspond to the first service components of the machine 100. In some cases, the first service components may include the cleaning head assembly 150 (e.g., one or more rotatable brushes, a sweeping brush, or polishing, burnishing, or buffing pads), the first, second, and third squeegees 124A, 124B, 125, a filter basket, a power cord/power source of the machine 100, the recovery tank, the solution tank, the one or more vision sensors 139 and/or front lower sensor 143, the rear lower sensor 141, and the side camera 142. These are just examples.

In some cases, the second markings that bear the second visual indicia may be provided on the second service components, positioned adjacent to the second service components, and/or provided as a part of the second service components. For example, the second markings may be positioned on an actuator that is used while performing the one or more maintenance tasks on the second service components. In another example, the second markings may include a portion of the second service components bearing the second visual indicia. In some cases, the second visual indicia may include a second color. In some cases, the second color is blue. In other cases, the second color may be teal, purple, yellow, or any other suitable color. In some cases, the second visual indicia may include a decal incorporating the second color that may be positioned on the machine 100 adjacent to the second service components. In some cases, the second visual indicia may include a second color and/or a decal including braille instructions. These are just examples.

As stated, the second visual indicia may correspond to the second service components of the machine 100. In some cases, the second service components may include the battery or other power source, such as the electrical charge cord 145, and the perimeter guard 130. These are just examples.

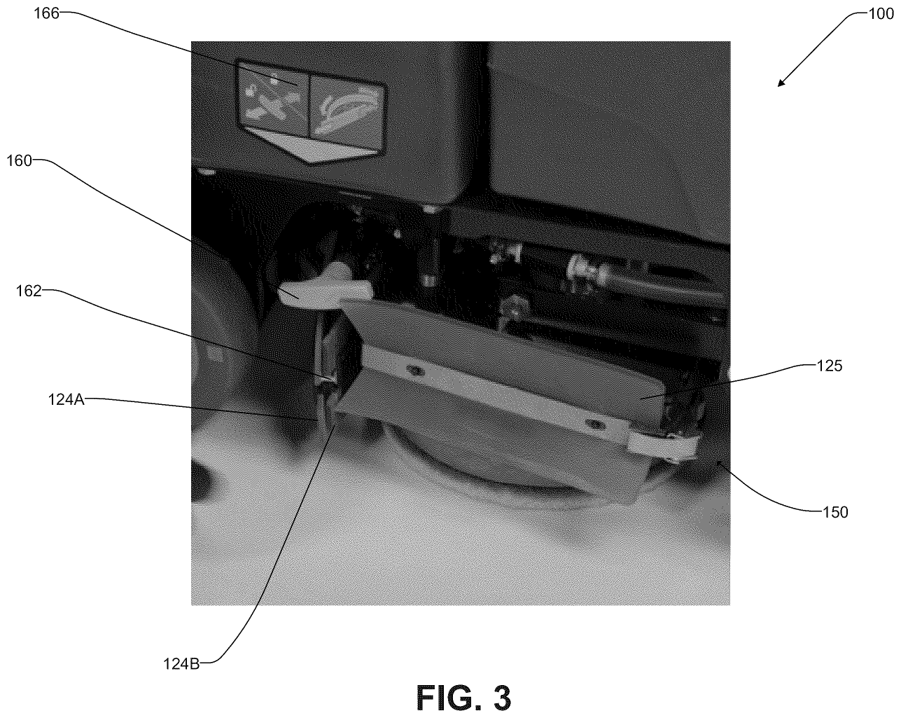

FIG. 3 is a lower, right-side view of the surface maintenance machine 100 showing an enlarged view of the cleaning head assembly 150, the first squeegee 124A, the second squeegee 124B, and the third squeegee 125. In FIG. 3, the first squeegee 124A and the second squeegee 124B are shown attached to a squeegee frame 162. The squeegee frame 162 may be attached directly or indirectly to an underside of the base 102 of the machine 100. In some instances, the first and second squeegees 124A, 124B may be releasably connectable to the squeegee frame 162. For example, as shown in FIG. 3, the squeegee frame 162 may include a release actuator, such as release lever 160. The release lever 160 may be used to help separate or disconnect the first and second squeegees 124A, 124B from the squeegee frame 162. While it is shown that the release actuator is the release lever 160, it may be contemplated that other release actuators may be used in addition or instead, such as release buttons or screw handles that are connected to threaded bolts or threaded nuts, which may form connectors.

The cleaning head assembly 150 may include one or more rotatable brushes, such as disc-shaped or cylindrical scrub brushes. Alternatively, the cleaning head assembly 150 can include other cleaning tools such as a sweeping brush, or polishing, burnishing or buffing pads. The brushes or pads are held by a driver (e.g., a brush driver or a pad driver respectively) that, together with the brush or pad, is detachable from a hub of the cleaning head assembly 150. In certain embodiments, the cleaning head assembly 150 includes a magnetic coupling system that allows for touch-free attachment and aligning between the pad driver or brush driver and the hub.

As previously discussed, the cleaning head assembly 150, the first squeegee 124A, the second squeegee 124B, and the third squeegee 125 may be considered as part of the first service components of the machine 100. As shown in FIG. 3, the first markings may be positioned on the release lever 160 (e.g., actuator) that is used while performing the one or more maintenance tasks on the first squeegee 124A and the second squeegee 124B. In such an example, the release lever 160 bears the first visual indicia corresponding to the first squeegee 124A and the second squeegee 124B. In this case, the first visual indicia is a first color (e.g., yellow). Additionally, a decal 166 is positioned on the machine 100 adjacent to the release lever 160, which also bears the first visual indicia, and the squeegee frame 162 further bears the first visual indicia, such as the first color. In another example, the first markings may include the first squeegee 124A and the second squeegee 124B bearing the first visual indicia, such as first squeegee 124A and/or the second squeegee 124B having the first color. The first visual indicia alerts an operator of the machine 100 that the first squeegee 124A and the second squeegee 124B need to be checked to determine if the first squeegee 124A and the second squeegee 124B need to be cleaned, flipped, and/or replaced, and if so, cleaning, flipping, and/or replacing the first squeegee 124A and/or the second squeegee 124B, respectively.

As shown in FIG. 3, the cleaning head assembly 150 includes the first markings which correspond to the cleaning head assembly 150 (e.g., a scrub brush). In this case, the cleaning head assembly 150 bears the first visual indicia, which includes the first color. The first markings on the cleaning head assembly 150 correspond to one or more maintenance tasks to be performed on the cleaning head assembly 150 and alerts an operator of the machine 100 that the cleaning head assembly 150 needs to be checked for damage, cleaned, flipped, or replaced, and if so, cleaning, flipping, and/or replacing cleaning head assembly 150. In other examples, a portion of the cleaning head assembly 150, such as some or all of the brushes on a scrub brush of the cleaning head assembly 150 may bear the first visual indicia, such as having the first color.

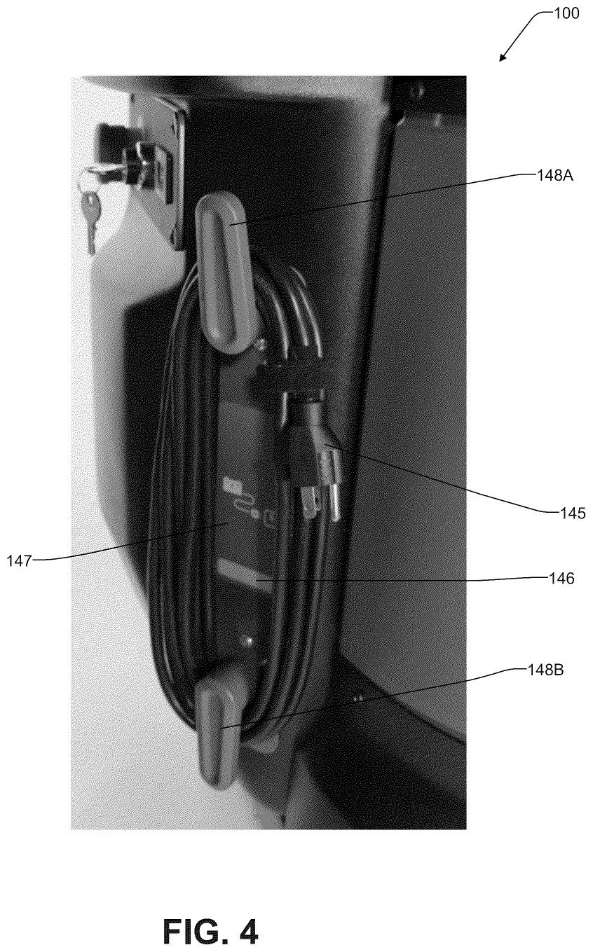

FIG. 4 is a rear side view of the surface maintenance machine 100 showing an enlarged view of the electrical charge cord 145 wrapped around the cord caddy 147. The electrical charge cord 145 that may be operatively coupled to the power source, (e.g., the one or more rechargeable batteries). The electrical charge cord 145 may be stored on the machine 100 using a power cord caddy 147. The power source can be configured to provide operational power to various (e.g., all) powered components at the machine 100. The electrical charge cord 145 may be plugged into an electrical outlet and used to charge the one or more rechargeable batteries.

The power source (e.g., internal batteries) may be considered as part of the first service components of the machine 100. As shown in FIG. 4, the first markings may be positioned on the electrical charge cord 145 and/or the cord caddy 147, as referenced by 146. In such an example, the cord caddy 147 bears the first visual indicia corresponding to the power source. In this case, the first visual indicia is a decal 146 bearing the first color (e.g., yellow). In other examples, the first markings may include the electrical charge cord 145 bearing the first visual indicia, such as the electrical charge cord 145 having the first color. In other examples, the first markings may include a first hook 148A and a second hook 148B of the cord caddy 147 bearing the first visual indicia, such as the first hook 148A and/or the second hook 148B having the first color. In yet another example, the first markings may include the entirety of the cord caddy 147 bearing the first visual indicia, such as the cord caddy 147 having the first color. The first visual indicia alerts an operator of the machine 100 that the electrical charge cord 145 needs to be plugged into an electrical outlet to recharge the one or more rechargeable batteries.

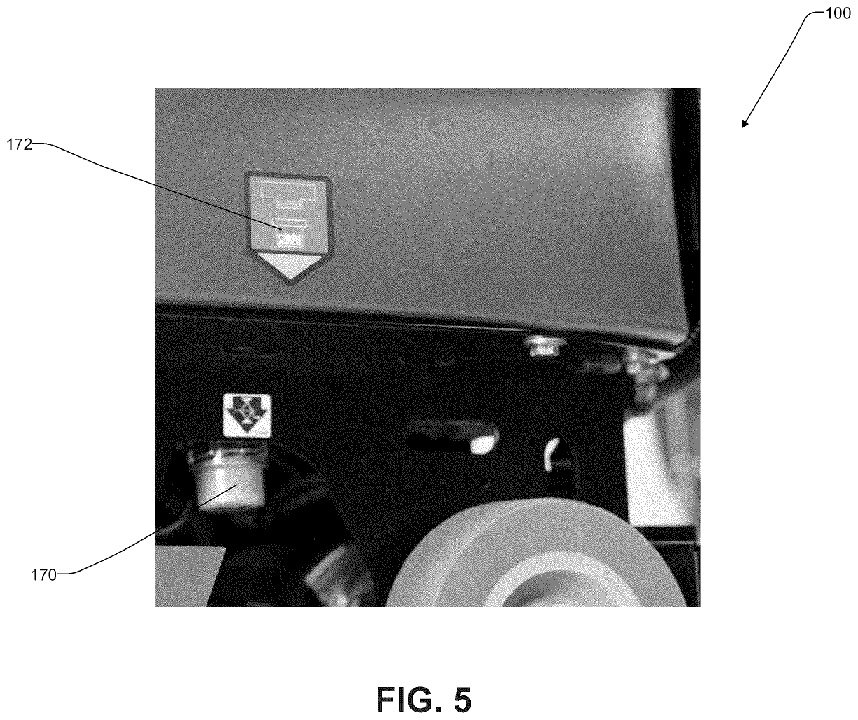

FIG. 5 is a left side view of the surface maintenance machine of 100 showing an enlarged view of a second marking corresponding to a cleaning solution filter 170. The cleaning solution filter 170 may be an in-line filter for a solution tank. The cleaning solution filter may be used to remove contaminants, such as hard water minerals, dirt, or the like, from the solution tank. The cleaning solution filter 170 may be considered as part of the second service components of the machine 100. As shown in FIG. 5, the second markings may be positioned on the machine 100 adjacent to the cleaning solution filter 170 (e.g., the second service components), as referenced by 172. In this case, the second markings include a decal bearing the second visual indicia. In such examples, the second visual indicia includes the second color. In other examples, the cleaning solution filter 170 may bear the second visual indicia, such as the cleaning solution filter 170 may include a cap having the second color. The second visual indicia alerts an operator of the machine 100 that the cleaning solution filter 170 needs to be removed, cleaned, and placed back on the machine 100.

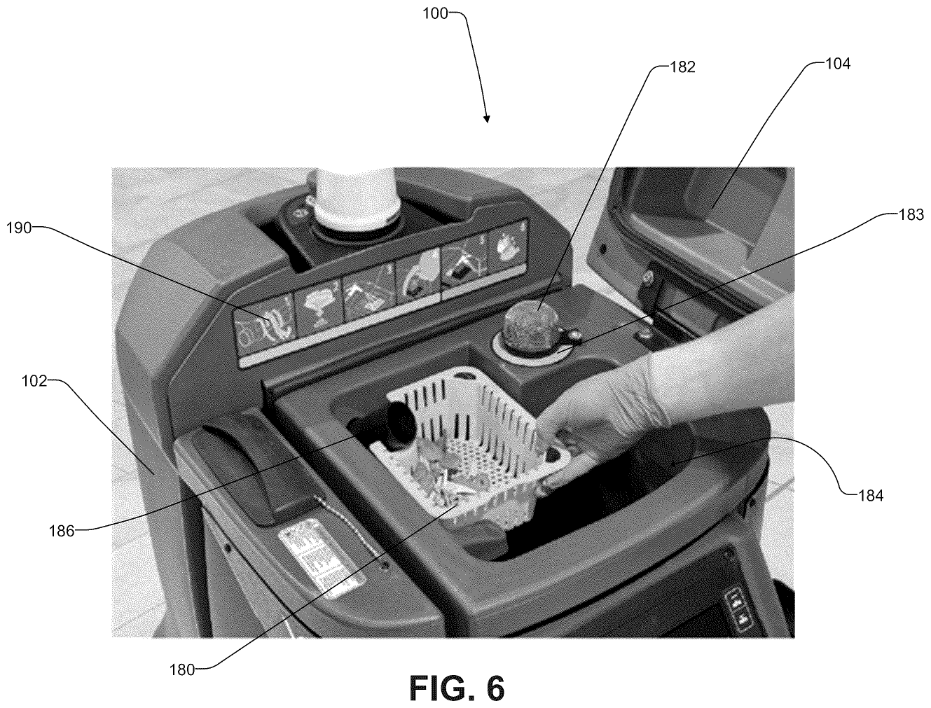

FIG. 6 is a top side view of the surface maintenance machine 100 with the recovery tank lid 104 in an open position, showing first markings bearing a first visual indicia and second markings bearing a second visual indicia. As shown in FIG. 6, the machine 100 may include a filter basket 180 and a filter screen 182. The filter basket 180 may be positioned within a recovery tank 184 such that soiled water from a vacuum hose 186 passes through the filter basket 180 before entering the recovery tank 184. In this manner, the filter basket 180 may catch any solid debris that has been collected by the vacuum hose 186. The filter basket 180 may be considered as part of the first service components of the machine 100. As shown in FIG. 6, the first markings may be positioned on the filter basket 180. In such an example, filter basket 180 bears the first visual indicia. In this case, the first visual indicia includes the filter basket 180 bearing the first color (e.g., yellow). In other examples, the first markings may include a portion of the filter basket 180 having the first color. In other examples, the first markings may include a decal bearing the first visual indicia. The first visual indicia alerts an operator of the machine 100 that the filter basket 180 needs to be emptied and cleaned.

The machine 100 further includes the filter screen 182. The filter screen 182 intercepts particles, eliminates bacteria, and traps dirt so as to prevent them from being expelled from the machine 100. The filter screen 182 may be considered as part of the second service components of the machine 100. As shown in FIG. 6, the second markings may be positioned on the machine 100 adjacent to the filter screen 182 (e.g., the second service components), as referenced by 183. In this case, the second markings include a decal bearing the second visual indicia. In such examples, the second visual indicia includes the second color. In other examples, the filter screen 182 may bear the second visual indicia, such as the filter screen 182 itself may include the second color. The second visual indicia alerts an operator of the machine 100 that the filter screen 182 needs to be cleaned.

As shown in FIG. 6, the machine 100 may include a decal 190 illustrating one or more maintenance tasks that need to be performed for first service components and second service components. The decal 190 may include first markings bearing the first visual indicia, wherein the first markings correspond to the first service components. The decal 190 may further include second markings bearing the second visual indicia, wherein the second markings correspond to the second service components.

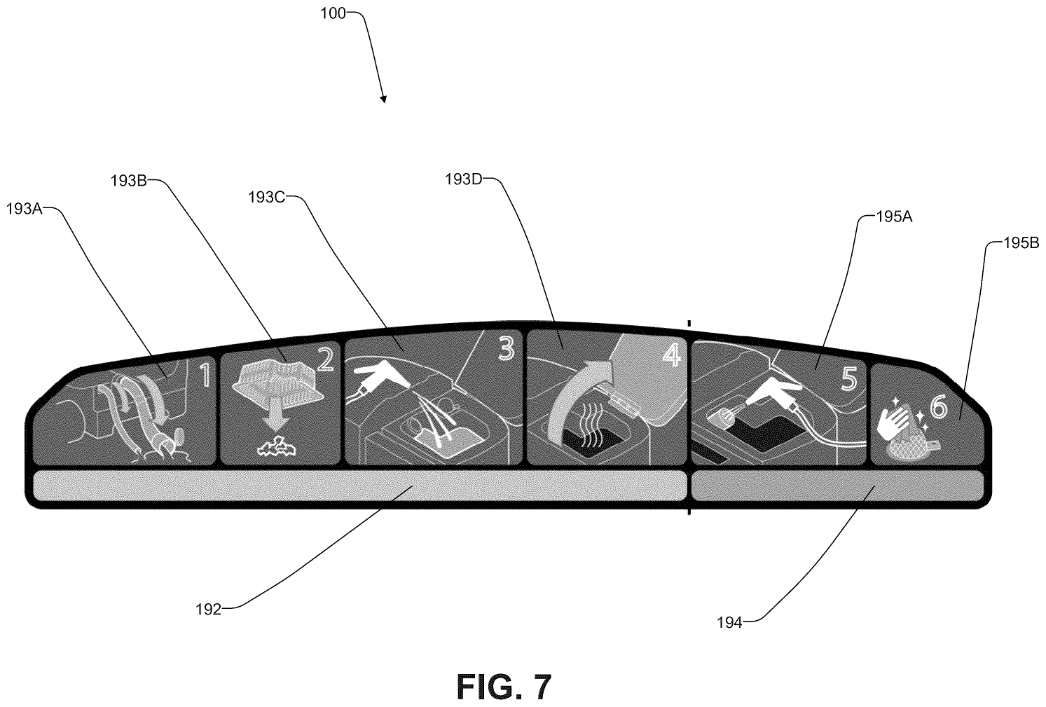

FIG. 7 illustrates an enlarged view of the decal 190. While FIG. 6 illustrates the decal 190 as being positioned on the machine 100, it may be contemplated that the decal 190 may instead be shown on a user interface, such as user interface 127. In such cases, an operator may be alerted to a maintenance schedule by viewing the decal 190 on the user interface 127. In other case, as shown in FIG. 6, the operator may be alerted to a maintenance schedule by viewing the decal 190 on the machine 100 itself. As shown in FIG. 7, the decal 190 may include first markings bearing the first visual indicia 192, wherein the first markings correspond to the first service components. In such cases, the first visual indicia may include the first color. In some cases, the first visual indicia may include the first color and braille instruction. As shown in FIG. 7, examples of one or more maintenance tasks to be performed on the first service components may include draining the recovery tank 193A, emptying the filter basket 193B, cleaning the recovery tank 193C, and letting the recovery tank dry 193D.

The decal 190 may further include second markings bearing the second visual indicia 194, wherein the second markings correspond to the second service components. In such cases, the second visual indicia 194 may include the second color. In some cases, the second visual indicia 194 may include the second color and braille instruction. As shown in FIG. 7, examples of one or more maintenance tasks to be performed on the second service components may include cleaning the vacuum hose 195A and cleaning the filter screen 195B.

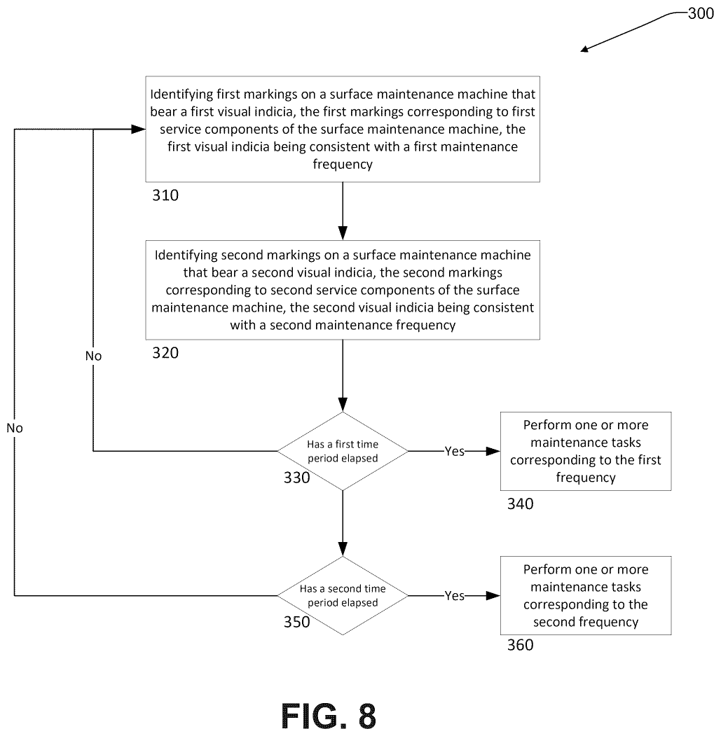

FIG. 8 illustrates an example flow chart for a method 300 of servicing a surface maintenance machine (e.g., surface maintenance machine 100). The method 300 may include identifying first markings on the surface maintenance machine that bear a first visual indicia, the first markings corresponding to first service components of the surface maintenance machine, the first visual indicia being consistent with a first maintenance frequency, as referenced by block 310. Further, identifying second markings on the surface maintenance machine that bear a second visual indicia, the second visual indicia being visually different from the first visual indicia, the second markings corresponding to second service components of the surface maintenance machine, the second visual indicia being consistent with a second maintenance frequency different from the first maintenance frequency, as referenced by block 320. The method 300 may include determining if a first time period corresponding to the first maintenance frequency has elapsed since a most recent performance of one or more maintenance tasks on the first service components, as referenced by block 330, and if so, performing the one or more maintenance tasks on the first service components, as referenced by block 340. And additionally, determining if a second time period corresponding to the second maintenance frequency has elapsed since a most recent performance of one or more maintenance tasks on the second service components, as referenced by block 350, and if so, performing the one or more maintenance tasks on the second service components, as referenced by block 360.

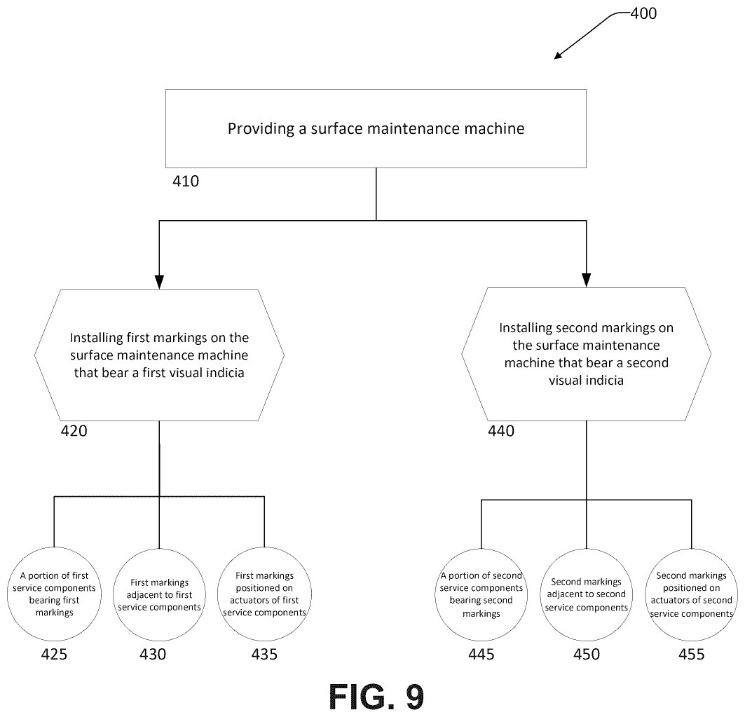

FIG. 9 illustrates an example flow chart for a method 400 of creating a surface maintenance machine (e.g., surface maintenance machine 100) having indicators of a maintenance schedule. The method may include providing a surface maintenance machine, such as surface maintenance machine 100 described herein, as referenced by block 410. The maintenance machine may include a mobile body, a solution tank for containing a supply of a cleaning fluid, wheels for supporting and transporting the mobile body, one or more surface maintenance tools supported by the mobile body, a first set of service components, and a second set of service components. The method 400 may further include installing first markings on the surface maintenance machine that bear a first visual indicia, as referenced by block 420, wherein the first markings correspond to the first service components of the surface maintenance machine. The first visual indicia may be consistent with a first maintenance frequency, the first markings being provided as part of or adjacent to the first service components. In some cases, a portion of the first service components may bear the first markings, as referenced by block 425. For example, the first service components may include a filter basket and the identifying first markings include identifying markings corresponding to the filter basket and the one or more maintenance tasks on the first service components include checking the filter basket and determining if the filter basket needs to be emptied/cleaned, and if so, emptying/cleaning the filter basket. In some cases, the filter basket bears the first markings, which may include the basket having a first color, including a decal consistent with the first color, or the like. In some cases, the first color is yellow. In other cases, the first color may be teal, purple, blue, or any other suitable color. In some cases, the first markings may include a first color and/or a decal including braille instructions. These are just examples.

In some cases, the first markings may be positioned adjacent to the first service components, as referenced by block 430, such as, for example, a decal positioned adjacent to the first service components. In some cases, the decal may include the first color corresponding to the first maintenance frequency. In some cases, as mentioned previously, the decal may include the first color and braille instructions. In some cases, the first markings may be positioned on one or more actuators of the first service components, as referenced by block 435, such as, for example, a squeegee release lever may include the first color and/or a decal including the first color and/or braille instructions.

The method 400 further includes installing second markings on the surface maintenance machine that bear a second visual indicia, as referenced by block 440. The second visual indicia being visually different from the first visual indicia, and the second markings corresponding to the second service components of the surface maintenance machine. The second visual indicia may be consistent with a second maintenance frequency different from the first maintenance frequency, the second markings being provided as part of or adjacent to the second service components. For example, a portion of the second service components may bear the second markings, as referenced by block 445. In some cases, the second markings may be positioned adjacent to the second service components, as referenced by block 450. For example, the second service components may include a filter screen, and the identifying second marks may include a decal positioned around the second service components, the decal including identifying marks, such as a second color corresponding to the filter screen, and the one or more maintenance tasks on the second service components may include cleaning the filter screen. In some cases, the second markings may be positioned on one or more actuators of the second service components, as referenced by block 455. In some cases, the second color is blue. In other cases, the second color may be teal, purple, yellow, or any other suitable color. In some cases, the first markings may include a second color and/or a decal including braille instructions. These are just examples.

While various examples of first markings and second markings have been described, it may be contemplated that any combination of said examples may be incorporated without departing from the scope of the disclosure.

Various non-limiting exemplary embodiments have been described. It will be appreciated that suitable alternatives are possible without departing from the scope of the examples described herein.

What is claimed is:

1. A method of servicing a surface maintenance machine, the method comprising:
identifying first markings on the surface maintenance machine that bear a first visual indicia, the first markings corresponding to first service components of the surface maintenance machine, the first visual indicia being consistent with a first maintenance frequency;
identifying second markings on the surface maintenance machine that bear a second visual indicia, the second visual indicia being visually different from the first visual indicia, the second markings corresponding to second service components of the surface maintenance machine, the second visual indicia being consistent with a second maintenance frequency different from the first maintenance frequency;
determining if a first time period corresponding to the first maintenance frequency has elapsed since a most recent performance of one or more maintenance tasks on the first service components, and, if so, performing the one or more maintenance tasks on the first service components; and
determining if a second time period corresponding to the second maintenance frequency has elapsed since a most recent performance of one or more maintenance tasks on the second service components, and, if so, performing the one or more maintenance tasks on the second service components.

2. The method of claim 1, wherein a portion of the first service components bear the first markings and/or a portion of the second service components bear the second markings.

3. The method of claim 1, wherein the first markings are positioned on the surface maintenance machine adjacent to the first service components and/or the second markings are positioned on the surface maintenance machine adjacent to the second service components.

4. The method of claim 1, wherein the first markings are positioned on actuators that are used when performing the one or more maintenance tasks on the first service components.

5. The method of claim 1, wherein first time period corresponds to a number of days in a range of about one day to about seven days.

6. The method of claim 1, wherein the first time period corresponds to an amount of time of surface maintenance machine has been used.

7. The method of claim 1, wherein the first maintenance frequency is servicing once every day, and the first time period is one day, or wherein the first maintenance frequency is servicing once every month, and the first time period is one month.

8. The method of claim 1, wherein the second maintenance frequency is servicing once every seven days, and the second time period is seven days.

9. The method of claim 1, wherein the first service components include a squeegee, the identifying first markings includes identifying markings corresponding to the squeegee and the one of the one or more maintenance tasks on the first service components include checking the squeegee of the surface maintenance machine, determining if the squeegee needs to be replaced, and if so, replacing the squeegee.

10. The method of claim 1, wherein the first service components include a scrub brush, the identifying first markings includes identifying markings corresponding to the scrub brush and the one or more maintenance tasks on the first service components include checking the scrub brush of the surface maintenance machine, determining if the scrub brush needs to be replaced, and if so, replacing the scrub brush.

11. The method of claim 1, wherein the first service components include a power cord used to charge a battery on the surface maintenance machine, the identifying markings corresponding to a power cord, and the one or more maintenance tasks include plugging a power cord into a power source to recharge a battery.

12. The method of claim 1, wherein the first visual indicia includes a first color, and the second visual indicia includes a second color different than the first color.

13. A method of creating a surface maintenance machine having indicators of a maintenance schedule, the method comprising:
providing a surface maintenance machine, the maintenance machine comprising:
a mobile body,
a solution tank for containing a supply of a cleaning fluid,
wheels for supporting and transporting the mobile body and,
one or more surface maintenance tools supported by the mobile body,
a first set of service components,
a second set of service components;
installing first markings on the surface maintenance machine that bear a first visual indicia, the first markings corresponding to the first service components of the surface maintenance machine, the first visual indicia being consistent with a first maintenance frequency, the first markings being provided as part of or adjacent to the first service components; and
installing second markings on the surface maintenance machine that bear a second visual indicia, the second visual indicia being visually different from the first visual indicia, the second markings corresponding to the second service components of the surface maintenance machine, the second visual indicia being consistent with a second maintenance frequency different from the first maintenance frequency, the second markings being provided as part of or adjacent to the second service components.

14. The method of claim 13, wherein the first service components include a filter basket, the identifying first markings includes identifying markings corresponding to the filter basket and the one of the one or more maintenance tasks on the first service components include checking the filter basket of the surface maintenance machine, determining if the filter basket needs to be emptied, and if so, emptying the filter basket.

15. The method of claim 14, wherein the filter basket bears the first markings.

16. The method of claim 13, wherein the second service components include a filter screen, the identifying second marks includes identifying marks corresponding to the filter screen and the one of the one or more maintenance tasks on the second service components include cleaning the filter screen.

17. The method of claim 13, wherein the first marking is a first decal positioned adjacent to the first service components, the first decal including a first color corresponding to the first maintenance frequency.

18. A surface maintenance machine having indicators of a maintenance schedule, comprising:
a mobile body;
a solution tank for containing a supply of a cleaning fluid;
wheels for supporting and transporting the mobile body;
one or more surface maintenance tools supported by the mobile body,
a first set of service components and,
a second set of service components;
first markings on the surface maintenance machine that bear a first visual indicia, the first markings corresponding to first service components of the surface maintenance machine, the first visual indicia being consistent with a first maintenance frequency, the first markings being provided as part of or adjacent to the first service components; and
second markings on the surface maintenance machine that bear a second visual indicia, the second visual indicia being visually different from the first visual indicia, the second markings corresponding to second service components of the surface maintenance machine, the second visual indicia being consistent with a second maintenance frequency different from the first maintenance frequency, the second markings being provided as part of or adjacent to the second service components.

19. The surface maintenance machine of claim 18, wherein the first visual indicia includes a first color, and the second visual indicia includes a second color different than the first color.

20. The surface maintenance machine of claim 19, wherein the first color is yellow and the second color is blue.

21. The surface maintenance machine of claim 18, wherein the first visual indicia includes a first symbol or image, and the second visual indicia includes a second symbol or image different from the first symbol or image.
